(19) United States
(12) Patent Application Publication
(10) Pub. No.: US 2026/0212630 A1
(43) Pub. Date: Jul. 23, 2026

(54) DIGITAL ASSET IDENTIFICATION AND MANAGEMENT FRAMEWORK

(71) Applicants: Geetha Y Ahilan, Glastonbury, CT (US); Daniel L. Campany, Wethersfield, CT (US); Sean M. Fournier, Portland, CT (US); Kurt R. Gannon, Glastonbury, CT (US); Karl G. Goode, Cheshire, CT (US); Prashant Nigam, South Windsor, CT (US); Dharmesh R. Pandya, West Hartford, CT (US); Matthew Jude Scott, West Hartford, CT (US); Steven B. Serafin, Annandale, NJ (US); Thomas J. Sibley III, San Antonio, TX (US); Jeffrey B Snyder, Wallingford, CT (US); David Ponce Tovar, Centennial, CO (US); Brian VanDeventer, Portland, CT (US); Ali J. Velasquez, San Antonio, TX (US)

(72) Inventors: Geetha Y Ahilan, Glastonbury, CT (US); Daniel L. Campany, Wethersfield, CT (US); Sean M. Fournier, Portland, CT (US); Kurt R. Gannon, Glastonbury, CT (US); Karl G. Goode, Cheshire, CT (US); Prashant Nigam, South Windsor, CT (US); Dharmesh R. Pandya, West Hartford, CT (US); Matthew Jude Scott, West Hartford, CT (US); Steven B. Serafin, Annandale, NJ (US); Thomas J. Sibley III, San Antonio, TX (US); Jeffrey B Snyder, Wallingford, CT (US); David Ponce Tovar, Centennial, CO (US); Brian VanDeventer, Portland, CT (US); Ali J. Velasquez, San Antonio, TX (US)

(21) Appl. No.: 19/250,379

(22) Filed: Jun. 26, 2025

Related U.S. Application Data
(60) Provisional application No. 63/747,577, filed on Jan. 21, 2025.

(51) Int. Cl. G06V 10/25

(52) U.S. Cl. CPC G06V 10/25; G06V 2201/07

(57) ABSTRACT

According to some embodiments, systems and methods are provided including a back-end application computer server including: a processor; a memory, coupled to the processor and storing instructions that, when executed by the processor, cause the back-end application computer server to: receive a first video-image from a user device; transmit a notification including a request for a second video-image, the second video-image different from the first video-image; receive the second video-image from the user device; identify at least one object in the second video-image; retrieve data for the identified object; and generate an object evaluation based on the retrieved data. Numerous other aspects are provided.

### CROSS-REFERENCE TO RELATED APPLICATION

The present application claims the benefit of U.S. Provisional Patent Application No. 63/747,577, entitled “DIGITAL ASSET IDENTIFICATION AND MANAGEMENT FRAMEWORK” filed Jan. 21, 2025. The entire content of that application is incorporated herein by reference.

### BACKGROUND

An enterprise may utilize equipment connected with its day-to-day operations. For example, a small business owner might have a restaurant that uses a gas stove and hood, a refrigerator, a fryer, etc. to prepare food. Another small business owner might have a construction business that uses bulldozers, excavators, backhoes, etc. Events may occur that result in costly disruptions to the day-to-day operations of the enterprise. As a non-exhaustive example, the refrigerator may need to be replaced, or the bulldozer may be damaged.

It would be desirable to provide improved systems and methods to help minimize disruptions and optimize operations. Moreover, the results should be easy to access, understand, interpret, update, etc.

### SUMMARY OF THE INVENTION

According to some embodiments, systems, methods, apparatus, computer program code and means are provided to accurately and/or automatically provide for the identification and protection of assets in a way that provides fast and useful results and allows for flexibility and effectiveness.

Some embodiments are directed to a digitized personalized risk assessment for a small enterprise, enterprise resilience, recommendations, trainings, validation and help guides.

Some embodiments are directed to a system implemented via a back-end application computer server. The system comprises a processor; a memory, coupled to the processor and storing instructions that, when executed by the processor, cause the back-end application computer server to: receive a first video-image from a user device; transmit a notification including a request for a second video-image, the second video-image different from the first video-image; receive the second video-image from the user device; identify at least one object in the second video-image; retrieve data for the identified object; and generate an object evaluation based on the retrieved data.

Some embodiments are directed to a method including receiving a first video-image from a user device; identify at least one object in the first video-image; transmitting a notification including a request for a second video-image based on the identified at least one object in the first video-image, the second video-image different from the first video-image; receiving the second video-image from the user device; identifying at least one object in the second video-image; retrieving data for the identified object in the second video-image; and generating an object evaluation based on the retrieved data.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is an improved and computerized way to manage and protect physical and virtual assets in a way that provides fast and useful results. With these and other advantages and features that will become hereinafter apparent, a more complete understanding of the nature of the invention can be obtained by referring to the following detailed description and to the drawings appended thereto.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a high-level block diagram of a system according to some embodiments of the present invention.

FIG. 2 illustrates a method according to some embodiments of the present invention.

FIG. 3 is a non-exhaustive example of a first user interface in accordance with some embodiments of the present invention.

FIG. 4 is a non-exhaustive example of a second user interface in accordance with some embodiments of the present invention.

FIG. 5 is a non-exhaustive example of a third user interface in accordance with some embodiments of the present invention.

FIG. 6 is a non-exhaustive example of a fourth user interface in accordance with some embodiments of the present invention.

FIG. 7 is a non-exhaustive example of a fifth user interface in accordance with some embodiments of the present invention.

FIG. 8 is a block diagram of an apparatus according to some embodiments of the present invention.

Throughout the drawings and detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate asset identification, protection and management. The present invention is directed to more than merely a computer implementation of a routine or conventional activity previously known in the industry as it provides a specific advancement in the area of electronic record analysis by providing improvements in the operation of a computer system that facilitates the identification of assets and management thereof, the assessment of enterprise vulnerabilities that could lead to operational disruption, and the assessment of risk coverage. Unlike risk advice for a generic enterprise, embodiments provide personalized recommendations based on real-time inputs and interactions with the user, making a more effective and reliable solution. The present invention provides improvement beyond a mere generic computer implementation as it involves the novel ordered combination of system elements and processes to provide improvements in the management of assets for a small business (e.g., less than three locations, each brick-and-mortar location of less than 5000 square feet, etc.). Some embodiments of the present invention are directed to a system adapted to automatically validate information, analyze electronic records, aggregate data from multiple sources, determine appropriate risk coverage and management steps, etc. Moreover, communication links and messages may be automatically established (e.g., to provide customized reports to users and alerts to appropriate parties within an enterprise), aggregated, formatted, exchanged, etc. to improve network performance (e.g., by reducing an amount of network messaging bandwidth and/or storage required to support obtaining asset information to identify the asset, manage operation of the asset and risk coverage of the asset).

The digital asset tool of one or more embodiments provides a personalized risk assessment. In particular, via an interactive video capture, the digital asset tool gathers detailed information about an environment (e.g., a restaurant) to inventory items and diagnose safety risks and potential causes for operational interruptions. Additionally, the digital asset tool provides enterprise resiliency recommendations. In particular, based on the personalized inventory, a user may be directed to the preventative solutions that suit their preferences, including resiliency tips, interactive self-help guides, online training, and access to a network of specialized technology solutions and professional services. Further, the digital asset tool provides scheduling and reminders. Particularly, the digital asset tool provides customized safety and maintenance routines, with tasks that can be pushed (e.g., via push notifications) or accessed via a checklist to make it easier for the user to implement preventative solutions and stay on track. The digital asset tool may provide recommendations regarding equipment maintenance downtime (e.g., to reduce the potential of equipment going down and reduce the disruption of the operations). The digital asset tool may also provide proactive risk solution recommendations, including, but not limited to, fire prevention, water damage, equipment monitoring and employee safety. In one or more embodiments, the digital asset tool provides coverage validation and potential additional recommendations of coverages the user may not have yet. By cataloguing all insurable property (e.g., assets/objects), including, but not limited to, contents, equipment, and machinery, with accurate and up-to-date monetary valuations, the digital asset tool ensures the user has adequate coverage for potential damage without incurring unnecessary costs. As a non-exhaustive example, the digital asset tool may catalog five items in a restaurant. The digital asset tool may then notify the user that the value of those five items is a total of $500K, with each item having a value of $100K. Based on analysis, the digital asset tool determines, however, the user only has $500K total of insurance coverage. The digital asset tool may then notify the user that there may be a gap in their coverage because they have all the other restaurant equipment (e.g., dishes, glasses, bar equipment), that would not be covered by their $500K, since those five items have a value of $500K and would have all of the coverage allotted thereto. Embodiments prevent risk and/or ensure users are not under-insured, thereby protecting users. By creating differentiated and customized user touchpoints, embodiments improve efficiency and provide more accurate protection for users. The digital asset tool may also suggest other types of coverage based on the type of business and/or the types of coverage applied to similar businesses (e.g., food spoilage coverage, equipment maintenance coverage, etc.). Embodiments may positively impact users by helping reduce risk (e.g., reducing frequency and severity of claimable events), and preventing costly operational interruptions.

A non-exhaustive example of a small restaurant will be used herein to facilitate explanation. Embodiments apply to any other suitable small enterprise (e.g., manufacturing plant, physician's office, dentists, veterinarians, constructions enterprises, etc.).

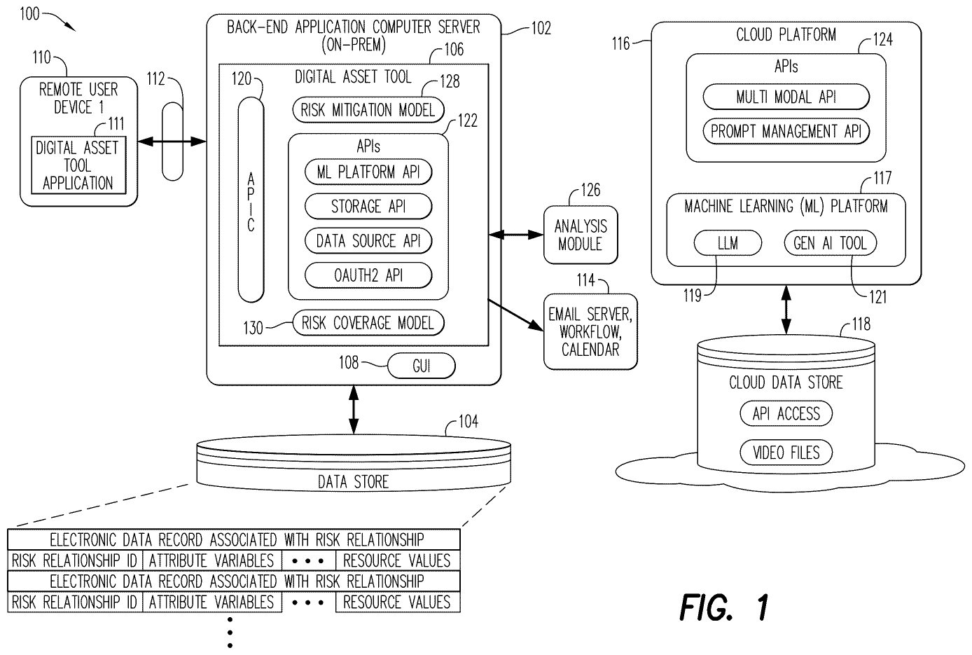

FIG. 1 is a high-level block diagram of a system 100 according to some embodiments of the present invention. In particular, the system 100 includes a back-end application computer server 102 that may access information in a data store 104 (e.g., storing a set of electronic records representing risk relationships of various types, each record including, for example, a set of attribute values including, but not limited to, one or more risk relationship identifiers, attribute variables, resource values, policy details, etc.) The back-end application computer server 102 may also access information from other data store or sources. The information may be accessed in connection with a digital asset tool 106 that applies machine learning or artificial intelligence algorithms and/or models to received data and the electronic records. The back-end application computer server 102 may retrieve information from a machine learning platform 117 in connection with the digital asset tool 106.

The back-end application computer server 102 may also utilize a Graphical User Interface (“GUI”) 108 to view, analyze, and/or update the electronic records. The back-end application computer server 102 may also exchange information with a remote user device 110 (e.g., via communication port 112 that might include a firewall). Back-end application computer server 102 may also transmit information directly to an email server (or postal mail server), a workflow application, and/or a calendar application 114 to facilitate recommendation processing and alerts. For example, the remote user device 110 may transmit an image of a fridge and/or audio associated with the fridge (e.g., compressor noise) to the back-end application computer server 102 via a digital asset tool application 111. Based on the image and/or audio, the back-end application computer server 102 may retrieve information and/or adjust data in the data store 104 and/or transmit information to a cloud platform 116 and/or cloud data store 118 associated therewith. The digital asset tool application 111 may be a mobile application accessed via the remote user device 110 as shown herein, or may be a standalone application. As described herein, the back-end application computer server 102 and/or any of the other devices and methods described herein might be associated with a cloud-based environment (e.g., cloud platform 116) and/or a third party, such as a vendor that performs a service for an enterprise.

Presentation of a user interface via the GUI 108 may include any degree or type of rendering, depending on the type of user interface code generated by the back-end application computer server 102. For example, a user (not shown) may execute a Web Browser to request and receive a Web page (e.g., in HTML format) from back-end application computer server 102 via HTTP, HTTPS, and/or WebSocket, and may render and present the Web page according to known protocols.

The digital asset tool 106 may include an Application Policy Infrastructure Controller (APIC) 120 acting as a proxy, one or more Application Programming Interfaces (APIs) 122 on the back-end application computer server 102 and one or more cloud platform APIs 124 on the cloud platform 116 and a machine learning platform 117 on the cloud platform 116. The APIC 120 may facilitate communication between the back-end application computer server 102 and external resources, such as the internet. APIs may be created in APIC to point to one or more services provided by cloud platform APIs 124 on the cloud platform 116. The APIs 122 on the backend application computer server include, but are not limited to, a Machine Learning (ML) platform API, a Storage API, a Data Source API (e.g., Big Query API® from Google®), an OAuth2 API, and any other suitable API. The ML platform API allows for integration with the cloud platform APIs 124. The storage API is an interface that allows applications to interact with storage systems (local 104 and cloud-based 118) by providing methods for storing, retrieving, and managing data, often in a structured format like key-value pairs or objects. The Data Source API provides for the creation, management, sharing and querying of data in one or more data sources. The OAuth2.0 (“Open Authorization) API is an interface that provides access to the OAuth 2.0 authorization framework, allowing users to grant third-party applications limited access to their data on a web server without revealing their credentials. The cloud platform APIs 124 include, but are not limited to a Multi-Modal API and a Prompt Management API. The Multi-Modal API is an interface that can process and understand different types of real-time data, such as text, images, audio and video, simultaneously. The multi-modal API may receive text, audio, and video as input, process this data, and provide text and audio output. The prompt management API is an interface for storing, organizing and versioning prompts for interacting with large language models (LLMs) 119 of the machine learning (ML) platform 117. The prompt management API provides a centralized system for managing prompts used in generative AI applications. The ML platform 117 includes at least an LLM 119 and a generative (Gen) AI tool 121. The LLM may be an image LLM, a video/streaming LLM, or any other suitable LLM. In the case of the video/streaming LLM, it can understand and generate language related to video content. The video/streaming LLM leverages pre-trained LLMs to understand the context and meaning of videos (e.g., frames, objects, actions, text descriptions, audio). The Gen AI tool 121 generates text and synthesizes data in the form of one or more reports based on requests, received input and training data.

The back-end application computer server 102 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 102 (and/or other elements of the system 100) may facilitate access, analysis, and/or update of electronic records in the data store 104. As used herein, the term “automated” may refer to, for example, actions that can be performed with little (or no) intervention by a human.

As used here, devices, including those associated with the back-end application computer server 102 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 102 may store information into and/or retrieve information from data store 104 and/or cloud data store 118. The data stores 104, 118 may be locally stored or reside remote from the back-end application computer server 102. As will be described further below, the data store 104, 118 may be used by the back-end application computer server 102 in connection with an interactive user interface to access, analyze and update electronic records. Although a single back-end application computer server 102 is shown in FIG. 1, any number of such devices may be included. Moreover, various devices described herein might be combined according to embodiments of the present invention.

The back-end application computer server 102 may be separated from or closely integrated with the data store 104/118. A closely-integrated server 102 may enable execution of services completely on the database platform, without the need for an additional server. For example, back-end application computer server 102 may provide a comprehensive set of embedded services which provide end-to-end support for Web-based applications. The services may include a lightweight web server, configurable support for Open Data Protocol, server-side JavaScript execution and access to SQL and SQLScript. The back-end application computer server 102 may provide application services (e.g., via functional libraries) using services that manage and query the database files stored in the data store 104/118. The application services can be used to expose the database data model, with its tables, views and database procedures, to clients. In addition to exposing the data model, the back-end application computer server 102 may host system services such as a search service, and the like.

Note that the system 100 of FIG. 1 is provided only as an example, and embodiments may be associated with additional elements or components. According to some embodiments, the elements of the system 100 automatically transmit information associated with an interactive user interface display over a distributed communication network.

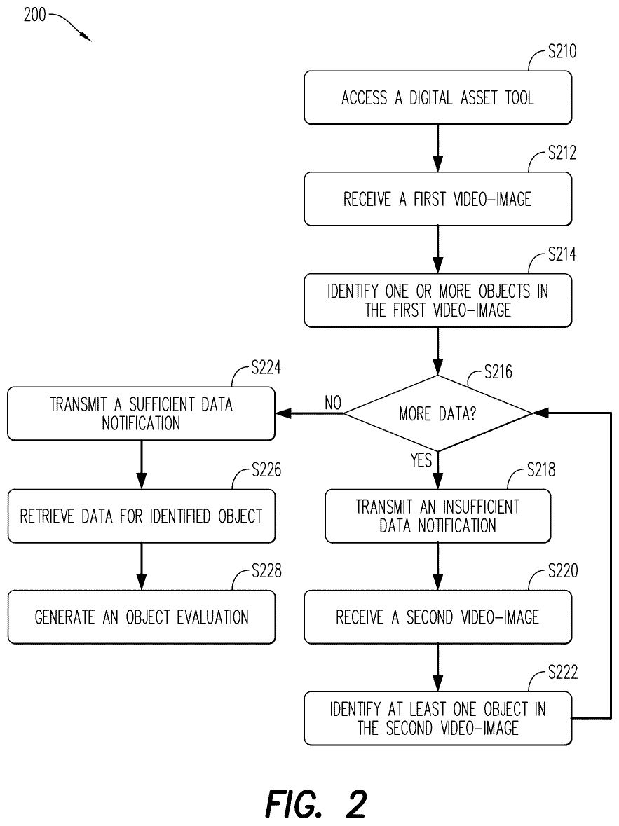

FIG. 2 illustrates a process 200 for generating an asset evaluation according to some embodiments. The process 200 may be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. For example, a computer-readable storage medium may store thereon instructions that when executed by a machine result in performance according to any of the embodiments described herein. Embodiments are not limited to the examples described below.

Initially, at S210, a digital asset tool 106 is accessed by a user. A user may access the digital asset tool 106 via at least one of multi-factor authentication and secure log-ins. User privacy may also be protected by encrypting the data prior to receipt by the tool. Pursuant to some embodiments, a client identifier/client secret is passed from the digital asset tool application 111 to the APIC 120. The APIC 120 receives the request and authenticates the user by: validating additional policy data; checking for OAuth tokens via the OAuth 2.0 API, and redirecting the request to an OAuth provider to get a token. The APIC 120 receives a token from the OAuth provider and passes the token to the multi-modal API for live streaming of the video. The multi-modal API may validate the token prior to streaming the video.

The digital asset tool 106 instructs the user to perform a self-guided tour of the facility. The digital asset tool receives a first video-image from the remote user device 110 in S212. The first video-image may be a real-time video of the self-guided tour, and the data is streamed via the APIC to a private service connect (PSC) endpoint (internal IP address) for the cloud platform 116. The PSC endpoint provides isolation and enhanced security by assigning a private IP address. The user uses webcams or built-in cameras on remote user devices like smartphones, tablets, smart glasses, virtual reality headsets, or other suitable user devices, and the audio and video recorded by the devices are encoded into numbers and sent to the digital asset tool 106. The digital asset tool 106 may instruct the user to take images and/or audio of particular objects/assets as part of the first video-image during the self-guided tour or may provide for an unstructured (e.g., no particular objects/assets required) self-guided tour.

Then in S214, the digital asset tool 106 identifies one or more objects in the received first video-image.

The digital asset tool 106, executing an Artificial Intelligence (AI) model (e.g., the LLM 119), determines the identity of various objects by using computer vision techniques, primarily “object detection”, which analyzes the image frame by frame, identifying key features like the shape, size, color, and spatial arrangement of the object, comparing them to a vast dataset of known objects (e.g., fridges), to classify the object as a fridge with a high degree of certainty. In one or more embodiments, the digital asset tool 106, also executing the AI model, may determine the identify of various objects by using computer audio techniques.

Continuing with the fridge example, prior to the use of the digital asset tool 106 in a self-guided tour, the LLM 119 “learns” what a fridge looks like from a large set of training data, allowing it to recognize similar features in new images or video frames. As such, a large collection of labeled images and videos where fridges are clearly identified are used to train the LLM 119. The LLM 119 employs feature extraction to analyze the image, extracting features like the rectangular shape, large flat surface, door handles, and typical color scheme of a fridge. Advanced algorithms, like Convolutional Neural Networks (CNNs), are used to process the image data and recognize patterns associated with a fridge. Once the LLM 119 detects a potential fridge, it creates a bounding box around it to indicate the object's location in the image. The LLM 119 assigns a confidence score to its prediction, indicating how likely it is that the detected object is actually a fridge. Pursuant to embodiments, the LLM 119 may consider the surrounding environment to help distinguish a fridge from similar objects, like a large cabinet. It is noted that the angle at which the camera captures the image and/or the lighting may affect the LLM's ability to recognize a fridge. Further, in one or more embodiments, the data received and analyzed by the digital asset tool 106 may be used to further train the digital asset tool 106 to ensure accuracy and reliability.

Similarly, and continuing with the fridge example, the LLM “learns” the different noises made by the parts associated with the fridge (and/or) local environment. As a non-exhaustive example, the LLM learns the noise made by a properly functioning fridge compressor and an improperly functioning fridge compressor. As another non-exhaustive example, the LLM learns the noise made by a properly functioning exhaust fan and an exhaust fan with build-up.

Next, in S216, the digital asset tool 106 determines—via the ML platform 117 and based on the identified one or more objects in the first video image-whether there is sufficient data.

In a case it is determined there is insufficient data in S216, a notification request message for more data is transmitted to the user device in S218. The notification request message may be in text or may be audible. The notification may include at least one of a request for a second video-image that is different from the first video-image, a request for a still-picture of an object, a request for additional data about one of the identified objects, and a request for other additional data about one or more not-yet-identified objects. The notification may include any other suitable request.

In S220, a second video-image is received from the remote user device 110, and at least one object in the second video-image is identified in S222. Pursuant to embodiments, the digital asset tool 106 may guide the user—via notification—as it's receiving the input from the camera of the remote user device to get closer to an object or upload a picture of an object for the digital asset tool 106 to acquire more detail.

As another non-exhaustive example, the digital asset tool 106 may identify an object in S214 as an LG® French Door Fridge with water dispenser. However, the digital asset tool 106 cannot identify the model number based on the received first video-image. The digital asset tool 106 instructs (e.g., via voice or text notification) the user to open the fridge and check for the model number on a sticker inside the fridge near the door. The digital asset tool 106 identifies the model number on the sticker as an object in the second video-image received from the remote user device.

Following identification of at least one object in the second video-image, the process returns to S216 to determine whether there is sufficient data.

In a case it is determined in S216 there is sufficient data, the process 200 proceeds to S224 and a notification is transmitted to the remote user device indicating the received first video-image data is sufficient.

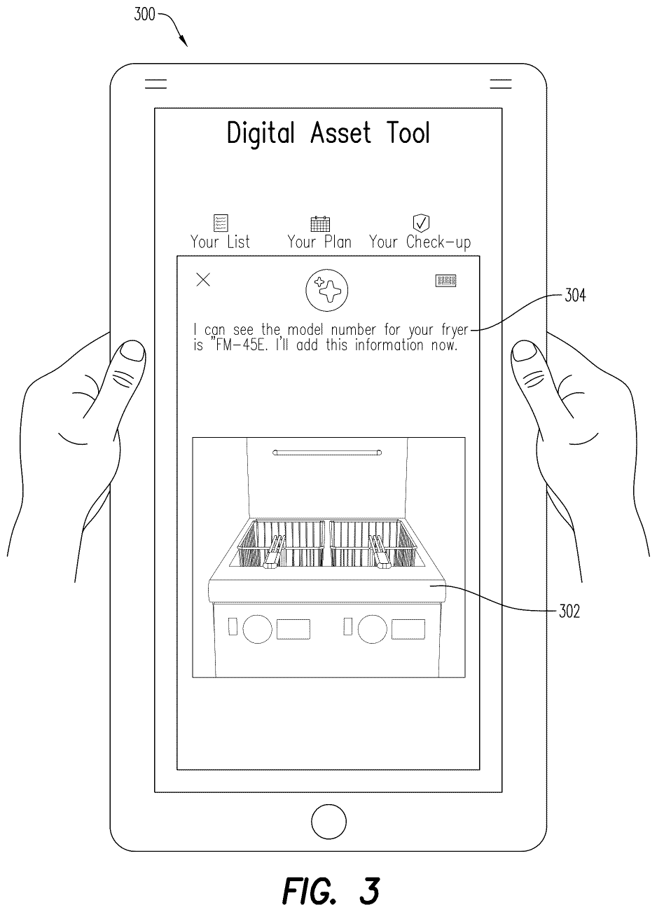

As a non-exhaustive example, FIG. 3 provides a UI display 300 with an object image 302 and a notification 304. Here, the notification 304 identifies the object (“I can see the model number for your fryer is “FM-4SE”. I'll add this information now”). Other suitable notifications may be provided including, but not limited to, requests for information, instructions, etc.

Then, in S226, the digital asset tool 106 retrieves data for at least one of the identified object(s) in the first video-image and the second video-image. Continuing with this non-exhaustive example, the digital asset tool 106 uses that model number to retrieve additional information about the object/asset (e.g., the model year, the retail prices of the model, whether the model is still available, similar replacement models, etc.). The digital asset tool 106 may retrieve a combination of internal data, web data, and other third-party data, to identify the objects, their values, claims and equipment replacement costs. The digital asset tool 106 may generate a query using the Gen AI tool 121 of the ML platform 117 to retrieve the data.

Based on the retrieved data, the digital asset tool 106 generates an object/asset evaluation in S228. The object/asset evaluation may be generated for each identified object. The object/asset evaluation may include at least one of a risk engineering report and other recommendations.

In some embodiments, the digital asset tool 106 may extract data regarding the identified objects based on the identified object(s) and retrieved data.

The extracted data may dynamically populate a risk assessment document form. A risk assessment for insurance purposes is a structured process used by insurers to identify, evaluate, and quantify potential risks associated with insurable assets or activities. This process helps determine the likelihood and financial impact of various risks, guiding decisions on premium pricing, coverage limits, and policy terms. The risk assessment document form includes data used in execution of the risk assessment. In response to population of the risk assessment document form, the risk engineering report is automatically generated. It is noted that often, a risk management policy (e.g., insurance policies) cannot be written unless a risk (mitigation) assessment is performed. The risk engineering report may provide recommendations to the user. As non-exhaustive examples, the risk engineering report may recommend the user at least one of: create more physical separation between the fryer and other flammable devices; reposition the sprinkler heads on the hood above the fryer; and remove the hand-towels draped over the oven; etc.

Pursuant to embodiments, the digital asset tool 106 determines, based on the identified object and retrieved data, the population of the risk assessment form may not be completed as one or more data items are missing from the identified object and retrieved data. In this case, the digital asset tool 106 transmits another notification to the remote user device including a request for the one or more missing data items, or information that may result in retrieval of the missing data item from the internal data source and/or third-party data source.

The digital asset tool 106 may be executed when equipment is received, at a renewal time for the risk management policy, at particular intervals, and/or other suitable frequency. Execution of the digital asset tool 106 may result in a reduction in expenditure for the user.

In addition to the risk engineering report, the extracted data may also be used to provide other recommendations. In one or more embodiments, the extracted data may be transmitted to an analysis module 126. The analysis module 126 may generate one or more recommendations. The recommendation may be at least one of: a recommendation for no changes based on a determination the current coverage is sufficient; a recommendation for additional coverage in a case the digital asset tool 106 determines the user does not have enough of a particular coverage (e.g., the right limits set); a recommendation for another unique product in a case the digital asset tool 106 determines there are other products that may be beneficial to the user (e.g., compared to similar enterprises, based on video content, etc.). As a non-exhaustive example, the digital asset tool 106 identifies three fridges and determines—e.g., via the ML Platform 117—the enterprise includes a lot of perishable content. In this example, the digital asset tool 106 recommends additional coverage for mold, mildew and/or perishable goods. The digital asset tool 106 receives the recommendation from the analysis module 126 and pushes the recommendation to the remote user device 110.

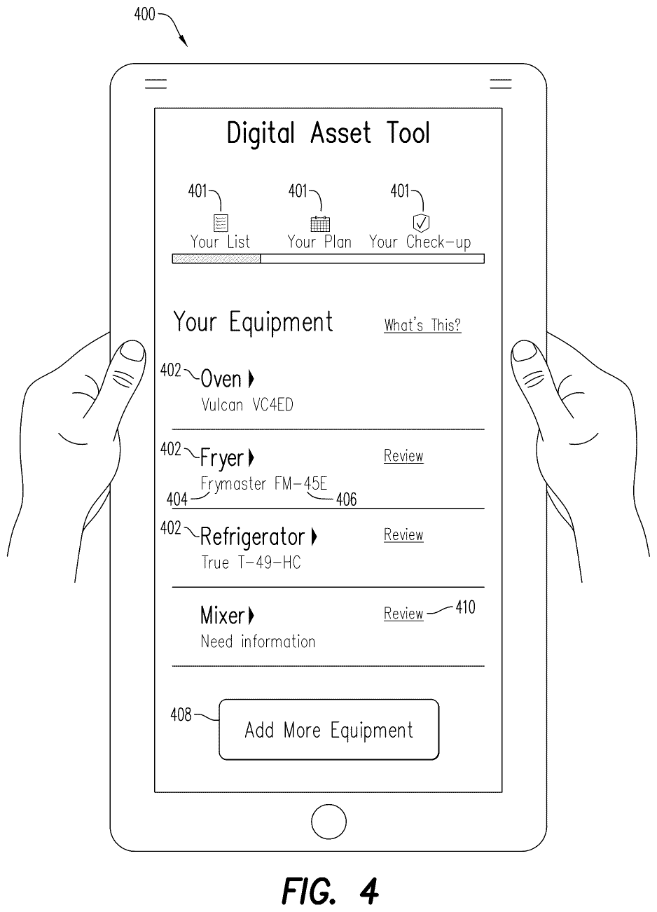

Pursuant to embodiments, the digital asset tool 106 may present the identified objects on a user interface (UI) 400, as shown in FIG. 4. The UI 400 includes a plurality of tabs 401. The plurality of tabs are: Your List, Your Plan, and Your Check-Up. Other suitable tabs may be included. Here, the Your List tab 401 is selected. The Your List tab 401 lists each of the identified assets/objects (equipment) 402 from the self-guided tour. Here the list includes the following identified assets: an oven, a fryer, a refrigerator (fridge), and a mixer. The digital asset tool 106 has identified, via the ML platform 117 and an asset identification model, the brand of each asset 404 and the asset model number 406. The user interface 400 includes an “Add More Equipment” icon 408. Selection of the “Add More Equipment” icon 408 allows the user to manually add more equipment/asset/objects via another screen (not shown), or to add more equipment via the camera.

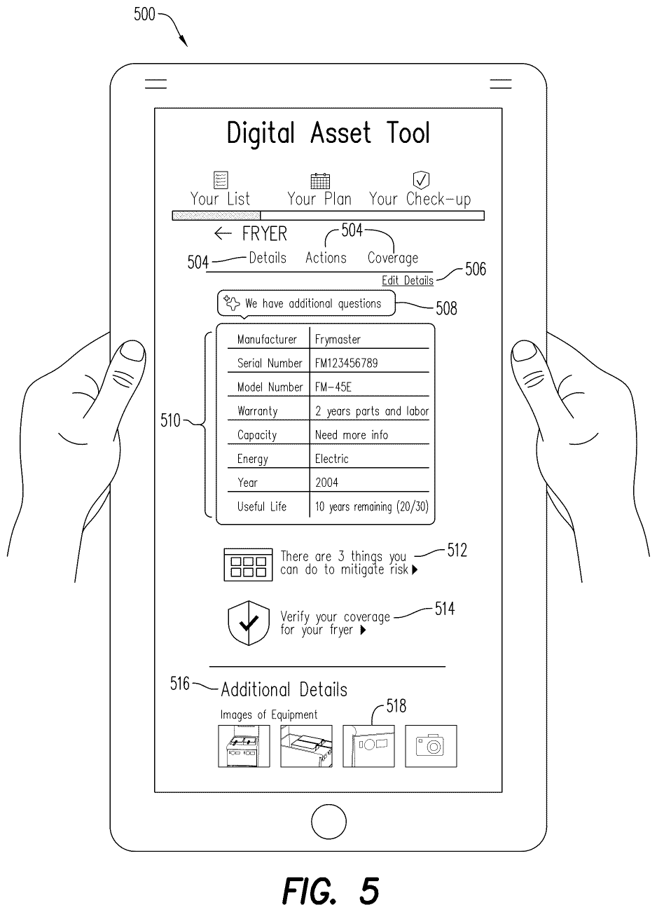

A “review” link 410 may be provided for each identified object. Selection of the “review” link 410 provides a Review UI 500, as shown in FIG. 5. The Review UI 500 displays the object (here, the object is “Fryer”) and a plurality of sub-tabs 504. The sub-tabs 504 may be based on the selected tab 401 (FIG. 4). Here, the sub-tabs 504 for the Your List tab 401 are: Details, Actions and Coverage. Other suitable sub-tabs may be provided. Here, the Details sub-tab 504 is selected. The Details sub-tab 504 includes an Edit Details link 506, an Additional Questions notification 508, and extracted data 510 for the identified object. Selection of the edit details link 506 provides a pop-up window and/or other user interface adapted to receive data to change the object data. Here, the extracted data 510 includes, but is not limited to, values for the following parameters: manufacturer, serial number, model number, warranty, capacity, energy, year and useful life.

Additionally, the digital asset tool 106 may identify missing information and transmit a request (text, visual, audio) to the remote user device 110. The request may include instructions for the user indicating how the user should obtain the missing information. Here, the Additional Questions notification 508 is presented because more information is needed regarding the capacity extracted data.

Based on the received information, the digital asset tool 106 may determine one or more risk mitigation actions the user may perform to mitigate the risk to the asset. The digital asset tool 106 may execute a risk mitigation model 128, using the received information as input, to determine the one or more risk mitigation actions. The Details sub-tab 504 includes a risk mitigation actions link 512. Selection of the risk mitigation actions link 512 results in a pop-up window or other user interface including the risk mitigation actions.

The Details sub-tab 504 may also include a verification link 514. Selection of the verification link 514 results in a pop-up window or other user interface. In response to selection of the verification link 514, the digital asset tool 106 retrieves existing risk coverage information for the selected asset from a data store 104.

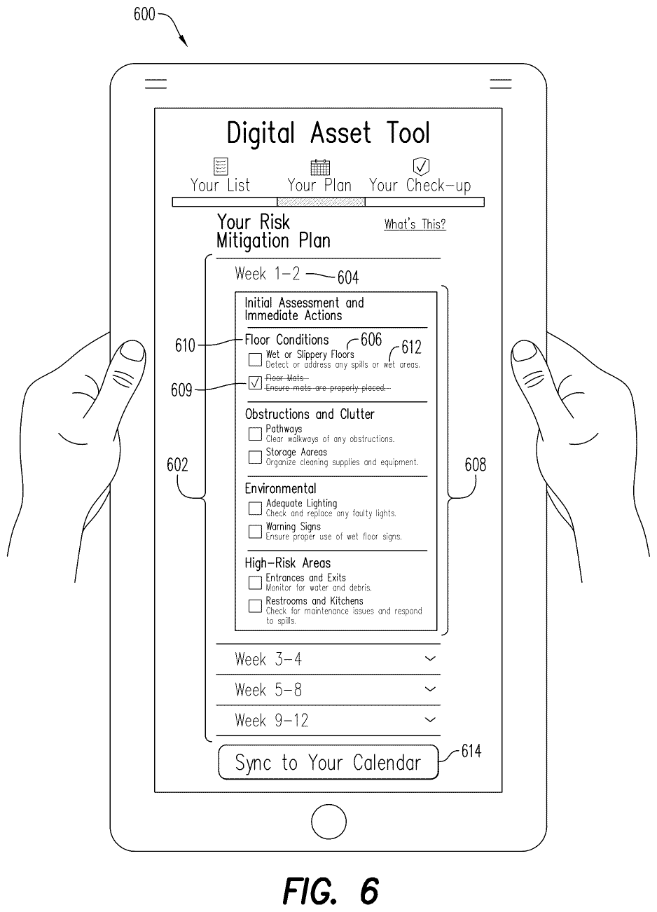

Additionally, the Details sub-tab 504 may include an Additional Details section 516. The Additional Details section 516 may include a selectable image link 518 for each of the other objects (e.g., equipment) in the Your List tab 401. Selection of the selectable image link 518 results in the display of a review UI (e.g., Your Risk Mitigation Plan UI 600 of FIG. 6) for the selected object.

Turning back to FIG. 4, selection of the Your Plan tab 401 results in the display of the Your Risk Mitigation Plan User Interface (UI) 600 (FIG. 6). In response to selection of the Your Plan tab 401, the digital asset tool 106 executes the risk mitigation model 128, using the received data for one or more objects as input. The output of the risk mitigation model is 128 displayed in the Your Risk Mitigation Plan UI 600. The Your Risk Mitigation Plan UI 600 includes a timeline 602 including one or more time blocks 604. Each time block 604 includes one or more actions 606 to be performed to mitigate risk. The risk mitigation with respect to the Your Risk Mitigation Plan UI 600 includes actions to mitigate risk for the entire enterprise. This is in contrast to the object-specific risk mitigation actions provided in response to selection of the risk mitigation actions link 512 (FIG. 5). The timeline 602 may be organized by day, week, month or any other suitable timing schedule. Here, the timeline is organized by week blocks (e.g., weeks 1-2, weeks 3-4, weeks 5-8 and weeks 9-12). In response to selection of a time block 604, a drop-down list 608 is displayed. The drop-down list 608 includes one or more action categories 610. Each action category 610 may include one or more actions items 606 performable to mitigate risk. The drop-down list 608 may include check-boxes 609, or other suitable selectable markings, for the user to select as the action item is completed.

Here, selection of the Week 1-2 time block 604, displays a drop-down list 608 including action categories 610 of: Floor Conditions, Obstructions and Clutter, Environmental, and High-Risk Areas. The Floor Condition action category 610 includes two action items 606: Wet or Slippery Floors and Floor Mats. Each action item 606 includes a performable instruction/action 612. In the case of Wet or Slippery Floors, the performable instruction/action 612 is “Detect and address any spills or wet areas”. In the case of Floor Mats, the performable instruction/action 612 is “Ensure mats are properly placed.” In a case where the action is completed, the user selects the check-box 609, and the drop-down list 608 is updated to mark (e.g., via cross-out) the action as complete. In addition to updating the drop-down list 608, selection of the check-box 609 transmits the update to the data store 104 and the record is updated. Pursuant to some embodiments, an update of the record may result in updates to risk management rates.

The Your Risk Mitigation Plan UI 600 includes a “Sync to Your Calendar” icon 614. Selection of the “Sync to Your Calendar” icon 614 automatically syncs the time blocks 604 of the personalized risk mitigation plan to the user calendar. Based on the syncing, the digital asset tool 106 may send reminders, instructions and other notifications to the user's email and calendar via the email server, workflow, calendar 114.

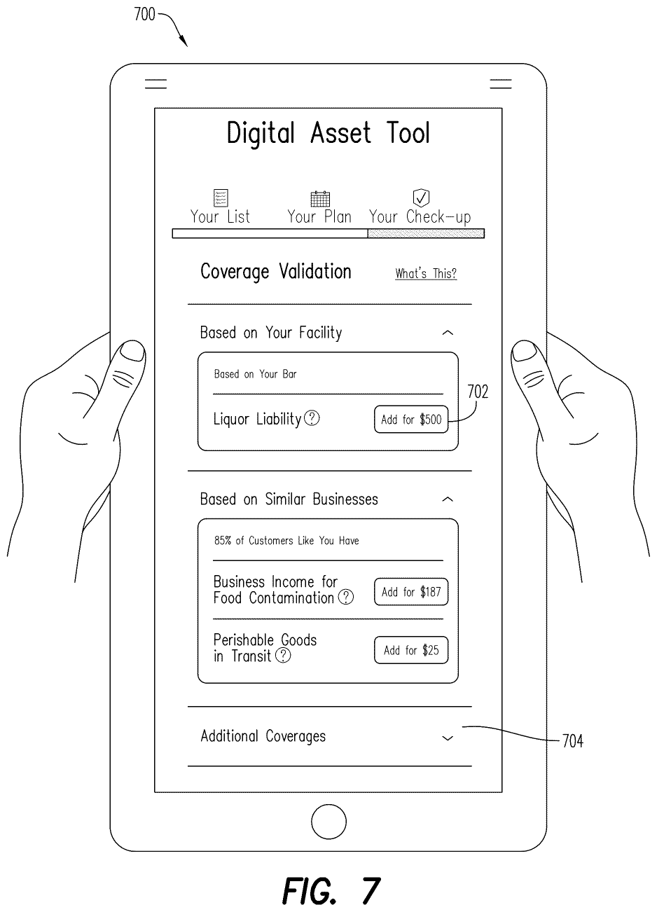

Turning back to FIG. 4, selection of the Your Check-up tab 401 results in the display of the Coverage Validation User Interface (UI) 700 (FIG. 7). Based on the received information, the digital asset tool 106 determines risk management coverage for the enterprise, as in S228 of FIG. 2. The digital asset tool 106 executes a risk management coverage model 130, using the received information as input. The digital asset tool 106 may output the risk management coverage for the enterprise. The digital asset tool 106 may then identify any risk coverage the enterprise already has (existing coverage) and compare the output risk management coverage to the existing coverage. The output of the comparison indicates the existing coverage is sufficient or the existing coverage is insufficient. In a case where the existing coverage is insufficient, the digital asset tool 106 determines risk management coverage to make the coverage sufficient. The risk management coverage to make the coverage sufficient may be the proposed risk management coverage. The Coverage Validation UI 700 displays existing coverage (not shown) and proposed risk management coverage to make the coverage sufficient. The proposed risk management coverage may be based on the individual enterprise, and/or based on similar enterprises. The Coverage Validation UI 700 includes selectable proposed coverage icons 702, whereby selection of the proposed coverage icon 702 may add the risk management coverage to the user record. The Coverage Validation UI 700 may also include an Additional Coverages drop down menu 704. The Additional Coverages drop down menu 704 may include one or more available risk management coverage policies that may be selected.

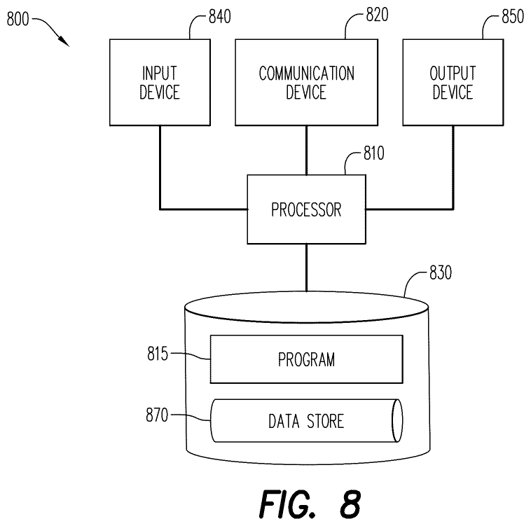

The embodiments described herein may be implemented using any number of different hardware configurations. For example, FIG. 8 illustrates an apparatus 800 that may be, for example, associated with system 100 described with respect to FIG. 1. The apparatus 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote third-party business or economic platforms, administrator computers, insurance agents, and/or communication devices (e.g., PCs and smartphones). Note that communications exchanged via the communication device 820 may utilize security features, such as those between a public internet user and an internal network of an insurance company and/or enterprise. The security features might be associated with, for example, web servers, firewalls, and/or PCI infrastructure. The apparatus 800 further includes an input device 840 (e.g., a mouse and/or keyboard to enter information, etc.) and an output device 850 (e.g., to output identified objects, recommendations, etc.).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 815 and/or an application for controlling the processor 810. The processor 810 performs instructions of the program 815, and thereby operates in accordance with any of the embodiments described herein. For example, the processor 810 may receive a video/image, automatically identify objects in the video/image, and based on the identified image, output an analysis/recommendation.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the apparatus 800 from another device; or (ii) a software application or module within the apparatus 800 from another software application, module, or any other source.

In some embodiments (such as shown in FIG. 8), the storage device 830 further includes a data store 870. Note that the database described herein is only an example, and additional and/or different information may be stored therein. Moreover, various databases might be split or combined in accordance with any of the embodiments described herein. For example, the data store 870 might be combined and/or linked with another data store within the program 815.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities, embodiments may instead be associated with other types of businesses in addition to and/or instead of those described herein (e.g., financial institutions, universities, governmental departments, any enterprise migrating a lot of data). Similarly, although certain types of certain attributes were described in connection with some embodiments herein, other types of attributes may be used instead. Still further, the displays and devices illustrated herein are only provided as examples, and embodiments may be associated with any other types of user interfaces.

The present invention has been described in terms of several embodiments solely for the purpose of illustration. Persons skilled in the art will recognize from this description that the invention is not limited to the embodiments described but may be practiced with modifications and alterations limited only by the spirit and score of the appended claims.

What is claimed is:

1. A system comprising:
a back-end application computer server including:
a processor;
a memory, coupled to the processor and storing instructions that, when executed by the processor, cause the back-end application computer server to:
receive a first video-image from a user device;
transmit a notification including a request for a second video-image, the second video-image different from the first video-image;
receive the second video-image from the user device;
identify at least one object in the second video-image;
retrieve data for the identified object; and
generate an object evaluation based on the retrieved data.

2. The system of claim 1, further comprising instructions to cause the back-end application computer server to:
identify one or more objects in the received first video-image.

3. The system of claim 2, wherein the notification is transmitted in response to a determination that more information is required based on the identified one or more objects in the received first video-image.

4. The system of claim 3, wherein the notification includes a request for a still-picture of at least one of the identified one or more objects, a request for additional data about at least one of the identified one or more objects, and a request for other additional data about one or more not-yet-identified objects.

5. The system of claim 2 further comprising instructions to cause the back-end application computer server to:
determine, based on the one or more identified objects, one or more missing data items.

6. The system of claim 1, further comprising instructions to cause the back-end application computer server to:
populate a risk assessment document with the retrieved data; and
transmit the populated risk assessment document.

7. The system of claim 6, further comprising instructions to cause the back-end application computer server to:
determine, based on the identified object and retrieved data, one or more missing data items from the populated risk assessment document; and
transmit a second notification to the user device, the second notification including a request for the one or more missing data items.

8. The system of claim 1, wherein the retrieved data is retrieved from at least one of an internal data source and a third-party data source.

9. The system of claim 1, wherein the at least one object is identified by a large language model (LLM).

10. The system of claim 1, wherein the object evaluation includes at least one recommendation.

11. The system of claim 10, wherein the recommendation is pushed to the user device.

12. A computer-implemented method comprising:
receiving a first video-image from a user device;
identify at least one object in the first video-image;
transmitting a notification including a request for a second video-image based on the identified at least one object in the first video-image, the second video-image different from the first video-image;
receiving the second video-image from the user device;
identifying at least one object in the second video-image;
retrieving data for the identified object in the second video-image; and
generating an object evaluation based on the retrieved data.

13. The computer-implemented method of claim 12, wherein the notification includes a request for a still-picture of at least one of the identified at least one object in the first video-image, a request for additional data about at least one of the identified one or more objects in the first video-image, and a request for other additional data about one or more not-yet-identified objects.

14. The computer-implemented method of claim 12, further comprising:
populating a risk assessment document with the retrieved data; and
transmitting the populated risk assessment document.

15. The computer-implemented method of claim 14, further comprising:
determining, based on the identified object and retrieved data, one or more missing data items from the populated risk assessment document; and
transmitting a second notification to the user device, the second notification including a request for the one or more missing data items.

16. The computer-implemented method of claim 12, wherein the at least one object is identified by a large language model (LLM).

17. The computer-implemented method of claim 12, wherein the retrieved data is retrieved from at least one of an internal data source and a third-party data source.

18. A non-tangible, computer-readable medium storing instructions that, when executed by a processor, cause the processor to perform a method via a back-end application computer server, the method comprising:
receiving a first video-image from a user device;
identify at least one object in the first video-image;
transmitting a notification including a request for a second video-image based on the identified at least one object in the first video-image, the second video-image different from the first video-image;
receiving the second video-image from the user device;
identifying at least one object in the second video-image;
retrieving data for the identified object in the second video-image; and
generating an object evaluation based on the retrieved data.

19. The media of claim 18, wherein the at least one object is identified by a large language model (LLM).

20. The media of claim 18, wherein the retrieved data is retrieved from at least one of an internal data source and a third-party data source.
